(19) United States
(12) Patent Application Publication
(10) Pub. No.: US 2021/0124974 A1
(43) Pub. Date: Apr. 29, 2021

(54) METHOD, APPARATUS, AND DEVICE FOR PROCESSING IMAGE AND STORAGE MEDIUM

(71) Applicant: Shanghai SenseTime Lingang Intelligent Technology Co., Ltd., Shanghai (CN)

(72) Inventors: Peiwen LIN, Shanghai (CN); Guangliang CHENG, Shanghai (CN); Jianping SHI, Shanghai (CN)

(21) Appl. No.: 17/139,276

(22) Filed: Dec. 31, 2020

Related U.S. Application Data
(63) Continuation of application No. PCT/CN2020/075874, filed on Feb. 19, 2020.

(30) Foreign Application Priority Data
Aug. 21, 2019 (CN) 201910775256.2

(51) Int. Cl. G06K 9/46; G06N 3/04

(52) U.S. Cl. CPC G06K 9/46; G06N 3/04

(57) ABSTRACT

The present disclosure provides a method, an apparatuses and a storage medium for processing an image. According to an example of the method, n times of feature extraction are performed on the to-be-processed image, to obtain a pixel feature recognition result. Each time of feature extraction includes p data nodes, in each time of feature extraction, data on each data node except the last data node is determined based on data obtained by processing data on each of the data nodes before the data node respectively via a preset feature extraction method in that time of feature extraction and input data of that time of feature extraction. A feature extraction method used in each time of feature extraction includes feature extraction methods used for data on the data nodes in that time of feature extraction. Thereafter, the to-be-processed image can be processed based on the pixel feature recognition result.

### CROSS-REFERENCE TO RELATED APPLICATIONS

This application is a continuation application of International Patent Application No. PCT/CN2020/075874, filed on Feb. 19, 2020, which is based on and claims priority to and benefit of Chines Patent Application No. 201910775256.2 filed on Aug. 21, 2019. The content of all of the above-identified applications is incorporated herein by reference in their entirety.

### TECHNICAL FIELD

The present disclosure relates to signal processing technology, and more particularly to a method, an apparatus, and a device for processing images, and a storage medium thereof.

### BACKGROUND

With the rapid development of deep learning technology, image recognition has been widely promoted and applied. An image recognition result can be obtained by performing multiple times of feature extraction processes on an image. The diversity and rationality of the feature extraction process methods are important factors that determine the quality of the image recognition result.

For example, when an image is to be subject to a feature extraction process, optimal neural network cells can be searched out by a neural network search method. The neural network cells that have been searched out are stacked to form a whole neural network. In other words, optimal feature extraction methods can be determined by a neural network search method, and the image can be subject to multiple times of feature extraction processes by the determined feature extraction methods, to obtain a feature recognition result of the image.

### SUMMARY

The present disclosure provides a method, an apparatuses and a storage medium for processing an image, in order to solve the problem of low image content recognition accuracy in the existing image processing method.

In a first aspect, the present disclosure provides a method for processing an image, including: obtaining a to-be-processed image; performing n times of feature extraction on the to-be-processed image, to obtain a pixel feature recognition result of the to-be-processed image; wherein, an input data of each time of feature extraction is determined based on output data of previous k times of feature extraction; input data of the first to k-th times of feature extraction include the to-be-processed image, wherein k is an integer greater than or equal to 1 and less than n, and n is an integer greater than 1; each time of feature extraction includes p data nodes, wherein p is an integer greater than 1, in each time of feature extraction, data on one data node is determined based on data obtained by processing data on each of the data nodes before the data node respectively via a preset feature extraction method in that time of feature extraction and input data of that time of feature extraction; a feature extraction method used in each time of feature extraction includes feature extraction methods used for data on the data nodes in that time of feature extraction; and an output data of each time of feature extraction is data on the last data node in that time of feature extraction; and processing the to-be-processed image based on the pixel feature recognition result of the to-be-processed image.

In combination with one or more examples, the method for processing an image is executed by a neural network, and each time of feature extraction in the n times of feature extraction is executed by a basic cell in the neural network.

In combination with one or more examples, for each time of feature extraction in the n times of feature extraction, the feature extraction method used in that time of feature extraction is determined by steps of: selecting any one data node of that time of feature extraction and any data node after the data node to constitute a target data node pair, wherein the target data node pair is associated with multiple candidate feature extraction methods; constituting a first connection vector with weight values of all the multiple candidate feature extraction methods, wherein a weight value of each candidate feature extraction method is an arbitrary value; normalizing the first connection vector, to obtain a first feature vector, with only one element of the first feature vector having a value 1 and the remaining elements all having a value 0; determining a candidate feature extraction method corresponding to an element with a value 1 as the target feature extraction method associated with the target data node pair, to be used to process data of the former data node in the target data node pair, and transfer the processed data to the latter data node in the target data node pair.

In combination with one or more examples, when determining the feature extraction method used in that time of feature extraction, the method further includes: correcting each first feature vector in that time of feature extraction with a graph convolution method based on the feature extraction method used in the previous time of feature extraction adjacent to that time of feature extraction; and determining the feature extraction method used in that time of feature extraction based on the corrected first feature vectors.

In combination with one or more examples, correcting each first feature vector in that time of feature extraction with a graph convolution method based on the feature extraction method used in the previous time of feature extraction adjacent to that time of feature extraction include: determining a connection matrix between a first matrix and a second matrix, wherein the first matrix is a matrix composed of the feature extraction method used in the adjacent previous time of feature extraction, and the second matrix is a matrix composed of first feature vectors in that time of feature extraction; and determining a correlation value between the connection matrix and the first matrix, and add the correlation value to the second matrix to obtain a third matrix; and determining corrected first feature vector in that time of feature extraction based on the third matrix.

In combination with one or more examples, processing the to-be-processed image based on the pixel feature recognition result of the to-be-processed image includes: performing feature extraction of at least one scale on the pixel feature recognition result of the to-be-processed image, to obtain a feature extraction result of at least one scale of the to-be-processed image; and processing the to-be-processed image based on the feature extraction result of at least one scale of the to-be-processed image.

In combination with one or more examples, for the feature extraction of each scale in the feature extraction of the at least one scale, determining the feature extraction method of that scale by steps of: constituting a second connection vector with weight values of multiple candidate feature extraction methods associated with the scale, wherein a weight value of each candidate feature extraction method is an arbitrary value; normalizing the second connection vector to obtain a second feature vector with only one element having a value 1 and the remaining elements all having a value 0; and determining a candidate feature extraction method corresponding to the element having a value 1 as the target feature extraction method associated with the scale, to perform feature extraction of the scale on the pixel feature recognition result of the to-be-processed image with the target feature extraction method.

In combination with one or more examples, for an i-th time of feature extraction in the n times of feature extraction, determining an input data of the i-th feature extraction by steps of: when i is greater than or equal to 1 and less than or equal to k, determining the to-be-processed image as the input data of the i-th time of feature extraction; when i is greater than k and less than or equal to n, determining respective output data of previous k times of feature extraction before the i-th time of feature extraction as the input data of the i-th time of feature extraction, wherein the respective output data of previous k times of feature extraction before the i-th time of feature extraction includes the (i−k)th processing result obtained by processing input data with a preset feature extraction method in the (i−k)th time of feature extraction, . . . , the (i−1)th processing result obtained by processing input data with a preset feature extraction method in the (i−1)th time of feature extraction.

In a second aspect, the present disclosure provides an apparatus for processing an image, including: an obtaining unit configured to obtain a to-be-processed image; a feature extraction unit configured to perform n times of feature extraction on the to-be-processed image, to obtain a pixel feature recognition result of the to-be-processed image; wherein, an input data of each time of feature extraction is determined based on output data of previous k times of feature extraction; input data of the first to k-th times of feature extraction include the to-be-processed image, wherein k is an integer greater than or equal to 1 and less than n, and n is an integer greater than 1; each time of feature extraction includes p data nodes, wherein p is an integer greater than 1, in each time of feature extraction, data on one data node is determined based on data obtained by processing data on each of the data nodes before the data node respectively via a preset feature extraction method in that time of feature extraction and input data of that time of feature extraction; a feature extraction method used in each time of feature extraction includes feature extraction methods used for data on the data nodes in that time of feature extraction; and an output data of each time of feature extraction is data on the last data node in that time of feature extraction; and a feature processing unit configured to process the to-be-processed image based on the pixel feature recognition result of the to-be-processed image.

In combination with one or more examples, the feature extraction unit includes a first basic processing subunit configured to, for each time of feature extraction in the n times of feature extraction, select any one data node of that time of feature extraction and any data node after the data node to constitute a target data node pair, wherein the target data node pair is associated with multiple candidate feature extraction methods; constitute a first connection vector with weight values of all the multiple candidate feature extraction methods, wherein a weight value of each candidate feature extraction method is an arbitrary value; normalize the first connection vector, to obtain a first feature vector, with only one element of the first feature vector having a value 1 and the remaining elements all having a value 0; determine a candidate feature extraction method corresponding to an element with a value 1 as the target feature extraction method associated with the target data node pair, to be used to process data of the former data node in the target data node pair, and transfer the processed data to the latter data node in the target data node pair.

In combination with one or more examples, the feature extraction unit further includes: a second basic processing subunit configured to, for each time of feature extraction except the first time of feature extraction of the n times of feature extraction, correct each first feature vector in that time of feature extraction with a graph convolution method based on the feature extraction method used in the previous time of feature extraction adjacent to that time of feature extraction; the first basic processing subunit is configured to determine the feature extraction method used in that time of feature extraction based on the corrected first feature vectors.

In combination with one or more examples, the second basic processing subunit includes: a first basic processing module configured to determine a connection matrix between a first matrix and a second matrix, wherein the first matrix is a matrix composed of the feature extraction method used in the adjacent previous time of feature extraction, and the second matrix is a matrix composed of first feature vectors in that time of feature extraction; and a second basic processing module configured to determine a correlation value between the connection matrix and the first matrix, and add the correlation value to the second matrix to obtain a third matrix; and a third basic processing module configured to determine corrected first feature vector in that time of feature extraction based on the third matrix.

In combination with one or more examples, the feature processing unit includes: a first feature processing subunit configured to perform feature extraction of at least one scale on the pixel feature recognition result of the to-be-processed image, to obtain a feature extraction result of at least one scale of the to-be-processed image; and a second feature processing subunit configured to process the to-be-processed image based on the feature extraction result of at least one scale of the to-be-processed image.

In combination with one or more examples, the first feature processing subunit includes: a first feature processing module configured to, for each of the at least one scale, constitute a second connection vector with weight values of multiple candidate feature extraction methods associated with the scale, wherein a weight value of each candidate feature extraction method is an arbitrary value; a second feature processing module configured to normalize the second connection vector to obtain a second feature vector with only one element having a value 1 and the remaining elements all having a value 0; and a third feature processing module configured to determine a candidate feature extraction method corresponding to the element having a value 1 as the target feature extraction method associated with the scale, to perform feature extraction of the scale on the pixel feature recognition result of the to-be-processed image with the target feature extraction method.

In combination with one or more examples, the feature extraction unit further includes: a third basic processing subunit configured to, for an i-th time of feature extraction in the n times of feature extraction, when i is greater than or equal to 1 and less than or equal to k, determine the to-be-processed image as the input data of the i-th time of feature extraction, when i is greater than k and less than or equal to n, determine respective output data of previous k times of feature extraction before the i-th time of feature extraction as the input data of the i-th time of feature extraction; and a fourth basic processing subunit configured to process the input data determined by the third basic processing subunit according to the feature extraction method determined by the first basic processing subunit, to obtain the output data of the i-th time of feature extraction.

In a third aspect, the present disclosure provides a device for processing an image, including: a processor, a memory, and a computer program, wherein the computer program is stored in the memory and is configured to be executed by the processor to implement the method of any one of described above.

In a fourth aspect, the present disclosure provides a computer-readable storage medium having a computer program is stored thereon, the computer program being executed by a processor to implement the method of any one of described above.

The present disclosure provides a method, an apparatuses and a storage medium for processing an image. The feature extraction methods used in the multiple times of feature extraction of a to-be-processed image are not exactly the same, which can effectively achieve more accurate and fine-grained pixel feature recognition result and can be beneficial to improve the recognition accuracy of the image recognition process.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a schematic flowchart illustrating a method for processing an image according to an example of the present disclosure.

FIG. 2 is a schematic flowchart illustrating another method for processing an image according to an example of the present disclosure.

FIG. 3 is a schematic structural diagram illustrating a basic cell according to an example of the present disclosure.

FIG. 4 is a schematic structural diagram illustrating a basic cell after a processing layer between data nodes is determined according to an example of the present disclosure.

FIG. 5 is a schematic diagram illustrating connection between a feature cell and a last basic cell according to this example.

FIG. 6 is a schematic diagram illustrating connection between a feature cell and the last basic cell after a processing layer is determined according to the example of the present disclosure.

FIG. 7 is a block diagram illustrating an apparatus for processing an image according to an example of the present disclosure.

FIG. 8 is a block diagram illustrating another apparatus for processing an image according to an example of the present disclosure.

FIG. 9 is a block diagram illustrating a device for processing an image according to an example of the present disclosure.

Through the above drawings, the specific examples of the present disclosure have been shown, which will be described in more detail below. These drawings and text descriptions are not intended to limit the scope of the concept of the present disclosure in any way, but to explain the concept of the present disclosure to those skilled in the art by referring to specific examples.

### DETAILED DESCRIPTION OF THE EXAMPLES

Examples will be described in detail herein, with the illustrations thereof represented in the drawings. When the following descriptions involve the drawings, like numerals in different drawings refer to like or similar elements unless otherwise indicated. The examples described in the following examples do not represent all examples consistent with the present disclosure. Rather, they are merely examples of apparatuses and methods consistent with some aspects of the present disclosure as detailed in the appended claims.

Terms involved in the present disclosure are briefly defined as follows.

Topological structure: a form in which nodes in a network are connected to one another.

Softmax function: or normalized exponential function, which can normalize a gradient logarithm of a finite-term discrete probability distribution.

Semantic segmentation (also known as image segmentation): a technology that divides an image into several specific areas with unique properties and proposes objects of interest, which is essentially a process of assigning labels to each pixel in the image.

Image recognition: a technology that processes, analyzes and understands an image with a computer, to identify targets and objects in various patterns.

Feature extraction: with a computer, extracting image information and determining whether points constituting an image belong to an image feature. The result of feature extraction is to divide points of an image into different subsets. These subsets can be isolated points, continuous curves or continuous regions.

Graph Convolutional Neural Network (GCN): an algorithm for deep learning of graph data.

Image features: including image color features, texture features, shape features, and spatial relationship features.

the method, apparatus, and device for processing images and a computer readable storage medium thereof provided in the present disclosure, the feature extraction methods used in multiple times of feature extraction processes on a to-be-processed image are not exactly the same, so that more accurate and fine-grained pixel feature recognition results can be achieved, which can improve the recognition accuracy of the image recognition process.

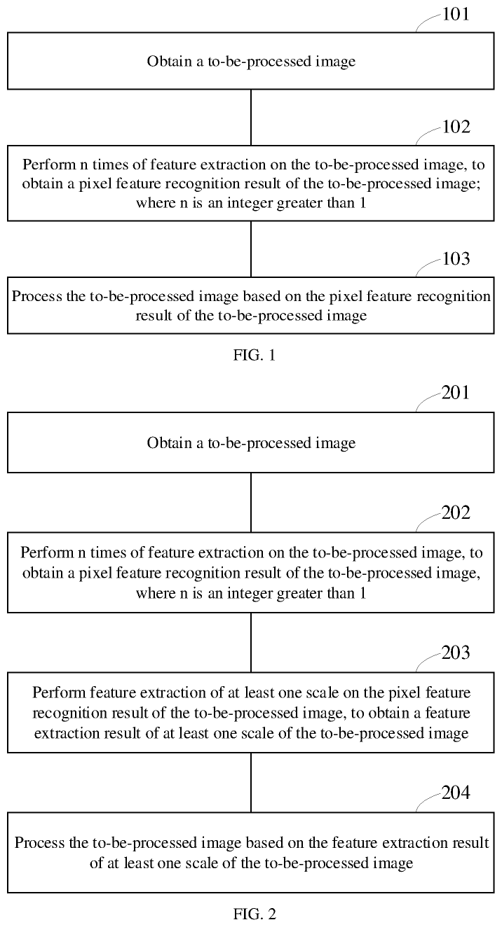

FIG. 1 is a schematic flowchart illustrating a method for processing an image according to an example of the present disclosure. As shown in FIG. 1, the method includes the following steps.

Step 101, a to-be-processed image is obtained.

The execution entity of this example can be a terminal, a controller, or other devices or equipment that can execute this example. For example, application software can be provided in the terminal, and then the terminal controls the application software to execute the method provided in this example.

The to-be-processed image can contain different object areas. For example, the to-be-processed image contains two object areas, i.e., a person and a motorcycle. In this case, it is necessary to use image recognition technology to segment different object areas from the to-be-processed image, mark the boundaries of the object areas, and recognize the content of the object areas. The source of the to-be-processed image can be an image taken with a capturing device, or it can be a network image, a screenshot image, or an electronic scan image.

Step 102, n times of feature extraction are performed on the to-be-processed image to obtain a pixel feature recognition result of the to-be-processed image. The input data of each of the n times of feature extraction is determined based on output data of previous k times of feature extraction; respective input data of the previous k of the n times of feature extraction includes the to-be-processed image; k is an integer greater than or equal to 1 and less than n, and n is an integer greater than 1.

Each time of feature extraction process includes p data nodes, wherein p is an integer greater than 1. In each time of feature extraction process, the data on each data node is determined based on data transferred to the data node by each data node before the data node in that time of feature extraction process and input data of that time of feature extraction. The data transferred by a data node is obtained by processing data of the data node by using a preset feature extraction method. The feature extraction method used in each time of feature extraction process includes feature extraction methods used for data on the data nodes in that time of feature extraction process; and the feature extraction methods used in each time of feature extraction process can be not exactly the same. The output data of each time of feature extraction process is the data on the last data node in that time of feature extraction process.

In this example, when k=1, the input data of each time of feature extraction is determined based on the output data of the previous time of feature extraction and the input data of the first time of feature extraction is the to-be-processed image; when k>1, the input data of each time of feature extraction is determined based on the output data of the previous multiple times, specifically k times, of feature extraction and the input data of more than one time of feature extraction includes the to-be-processed image. For example, when k=3, the input data of the first, second, and third times of feature extraction are determined based on the to-be-processed image, and the input data of the fourth time of feature extraction is based on the previous three times of feature extraction, that is, the output data of the first, second, and third times of feature extraction.

In each time of feature extraction process, for the first data node, the data of the first data node is input data for that time of feature extraction and the data of the first data node is processed by the preset feature extraction method respectively and then is transferred to the data nodes after the first data node. For a certain data node in the middle, the data of the data node is determined based on the data transferred to the data node by data nodes before the data node and the input data of that time of feature extraction, and the data of the data node is processed by the preset feature extraction method respectively and then is transferred to the data nodes after the data node. For the last data node, the data of the data node is determined based on the data transferred to the data node by data nodes before the data node and the input data of that time of feature extraction, and the data of the last data node is used as the output data of that time of feature extraction, and is transferred to the first data node of the first to k-th time of feature extraction after that time of feature extraction. In each time of feature extraction process, the feature extraction methods used for data on data nodes except the last data node can be independent of one another. The number of times that the data of a data node except the last data node is subjected to a preset feature extraction method is determined by the number of data nodes after that data node.

Taking p=4 as an example, for the first data node, the data of the first data node is the input data for that time of feature extraction and the data of the first data node is subject to three times of feature extraction processes by the preset feature extraction method respectively, and the data obtained from the three times of feature extraction processes is respectively transferred to the second, third, and fourth data nodes, wherein the feature extraction methods of the three times of feature extraction processes are independent of one another. For the second data node, the data of the second data node is determined by the data obtained by processing the data of the first data node using the preset feature extraction method and the input data of that time of feature extraction, data of the second data node is subjected to two times of feature extraction processes using the preset feature extraction method respectively, and the data obtained from the two times of feature extraction processes is respectively transferred to the third and fourth data nodes. For the third data node, the data of the third data node is determined by the data obtained by processing the data of the first and second data nodes using the preset feature extraction method respectively and the input data of that time of feature extraction, data of the third data node is subjected to one time of feature extraction process using the preset feature extraction method, and the data obtained from the one time of feature extraction process is transferred to the fourth data node. For the fourth data node, the data of the fourth data node is determined by processing the data of the first, second, and third data nodes using the preset feature extraction method respectively and the input data of that time of feature extraction, and data of the fourth data node is the output data of that time of feature extraction process.

Step 103, the to-be-processed image is processed based on the pixel feature recognition result of the to-be-processed image.

In this example, processing the to-be-processed image based on the obtained pixel feature recognition result can be content recognition processing on the to-be-processed image, specifically includes: determining an object category of each pixel in the to-be-processed image based on the pixel feature recognition result, dividing pixels belonging to the same object category into the same object area, and assigning the same number to the pixels in the same object area. In this way, by dividing the to-be-processed image into several disjoint object areas, and marking the different object areas, it can effectively realize the content recognition process of the to-be-processed image.

In this example, since the feature extraction methods used in the multiple times of feature extraction processes are not exactly the same, this is equivalent to using multiple neural network cells with different structures to perform feature extraction on the to-be-processed image, thereby it can effectively ensure the diversity of image pixel feature recognition. In addition, since the feature extraction methods in multiple times of feature extraction processes are independent of each other, the independence of various feature extraction methods can be effectively guaranteed, which can be beneficial to the realization of more accurate and fine-grained pixels feature recognition results.

FIG. 2 is a schematic flowchart illustrating another method for processing an image according to an example of the present disclosure. As shown in FIG. 2, the method includes the following steps.

Step 201, a to-be-processed image is obtained.

For this step, reference can be made to step 101 in FIG. 1 and will not be repeated.

Step 202, n times of feature extraction are performed on the to-be-processed image to obtain a pixel feature recognition result of the to-be-processed image.

The image processing method can be executed by a neural network, and each time of feature extraction process can be executed by a basic cell in the neural network. For example, a neural network can be composed of at least n basic cells, and each basic cell includes p data nodes, wherein n is an integer greater than 1, and p is an integer greater than 1.

Performing n times of feature extraction on the to-be-processed image with a neural network includes: inputting the to-be-processed image into the first basic cell of the neural network; and sequentially using the n basic cells in the neural network to perform the process on the to-be-processed image to obtain the pixel feature recognition result of the to-be-processed image. Specifically, for an i-th basic cell of the neural network, when i is greater than or equal to 1 and less than or equal to k, the i-th basic cell is used to perform feature extraction process on the to-be-processed image, and the obtained processing result is used as the i-th processing result. When i is greater than k and less than n, respective processing results of k basic cells before the i-th basic cell, including the (i−k)th processing result output by the (i−k)th basic cell, . . . , and the (i−1)th processing result output by the (i−1)th basic cell, are input to the i-th basic cell, to use the i-th basic cell to perform feature extraction process on the processing results of the previous k basic cells, to obtain the i-th processing result. When i is equal to n, respective processing results of k basic cells before the n-th basic cell, including the (n−k)th processing result output by the (n−k)th basic cell, . . . , and the (n−1)th processing result output by the (n−1)th basic cell, are input to the n-th basic cell, to use the n-th basic cell to perform feature extraction process on the processing results of the previous k basic cells, to obtain the n-th processing result as the pixel feature recognition result of the to-be-processed image. Where, the input data of the 1st to the k-th basic cell each include the to-be-processed image, and k is an integer greater than or equal to 1 and less than n.

Based on the above, the to-be-processed image is input respectively to the 1˜k basic cells of the neural network for feature extraction process, and then the processing results of the k basic cells previous to the i-th basic cell are input to the i-th basic cell sequentially (i is an integer greater than k and less than or equal to n), until each basic cell of the neural network has been used to perform feature extraction process to obtain the pixel feature recognition result of the to-be-processed image. In this way, the feature extraction process operations performed by all the basic cells constitute the feature extraction process operation performed on the to-be-processed image by the entire neural network. The feature extraction process method adopted by each basic cell include the feature extraction method adopted for data on all data nodes in the basic cell, and the feature extraction process method adopted by each basic cell can be independent of each other. In this way, it is possible to effectively ensure the diversity of the feature extraction process methods for the to-be-processed image, which can be beneficial to improve the accuracy of image recognition.

In each time of feature extraction process, it is necessary to determine the feature extraction method used by each data node to transfer the data to any subsequent data node in that time of feature extraction, which can specifically include: selecting any one data node of that time of feature extraction and any data node after the data node to constitute a target data node pair, wherein the target data node pair is associated with multiple candidate feature extraction methods, and any one of the multiple candidate feature extraction methods can be used to process data of the former data node in the target data node pair, and the processed data is transferred to the latter data node in the target data node pair; constituting a first connection vector with weight values of all the multiple candidate feature extraction methods, wherein a weight value of each candidate feature extraction method can be arbitrary; normalizing the first connection vector, to obtain a first feature vector, with only one element of the first feature vector having a value 1 and the remaining elements all having a value 0; determining a candidate feature extraction method corresponding to an element with a value 1 in the first feature vector, as the target feature extraction method associated with the target data node pair, to be used to process data of the former data node in the target data node pair, and transfer the processed data to the latter data node in the target data node pair.

When using a certain basic cell of the neural network to perform feature extraction process, the data of each data node in the basic cell except the last data node is processed sequentially using a preset feature extraction method, and the processed data is transferred to each data node after the data node until the last data node in the basic cell is reached, to obtain the pixel feature recognition result of the basic cell. The feature extraction process method used for the data on the data nodes except the last data node constitutes the feature extraction method of the basic cell; and, for each data node except the last data node, the feature extraction process operations performed on the data constitutes the feature extraction process operation of the basic cell.

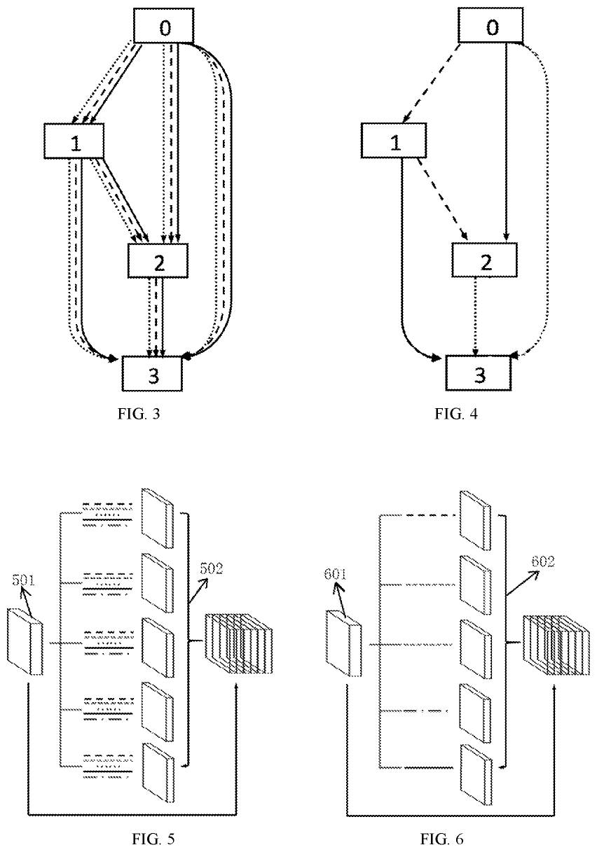

The data nodes can be numbered with preset node serial numbers, and sorted in order of the node serial numbers from small to large (for numeric node serial numbers) or from head to tail (for non-numeric node serial numbers, such as English letters, and others). FIG. 3 is a schematic structural diagram illustrating a basic cell according to an example of the present disclosure. As shown in FIG. 3, the basic cell includes 4 data nodes, and the node serial numbers of the 4 data nodes are 0, 1, 2, and 3 respectively. Correspondingly, when the data nodes are sorted from head to tail in order of the node serial numbers from small to large, the data node with a node serial number 0 is the first data node, and the data node with a node serial number 3 is the last data node. In a list of the node serial numbers, a node serial number of a certain data node is located before the node serial number of each data node after the data node. For example, in the list of node serial numbers, the data node of serial number i is located before the data node with node serial number i+1, which can also be expressed as the i-th data node is located in front of the (i+1)th data node. As shown in FIG. 3, for the No. 0 data node, data nodes after the data node include the No. 1, 2, and 3 data nodes. For the No. 1 data node, data nodes after the data node include the No. 2 and No. 3 data nodes; for the No. 2 data node, data nodes after the data node only include the No. 3 data node.

When using any basic cell of the neural network to perform feature extraction process, any one data node of that time of feature extraction is selected to constitute a target data node pair with any data node after the data node. A target feature extraction method associated with the target data node pair is used to process the data of the former data node in the target data node pair, and transfer the processed data to the latter data node in the target data node pair. The target data node pair can be associated with at least one candidate feature extraction method, such as convolution processing, pooling processing, and direct replacement processing. The feature extraction operation can be implemented by a processing layer. Correspondingly, the processing layer can include a convolutional layer, a pooling layer, a direct replacement layer, etc., which are configured to process the data of the former data node in the target data node pair, and transfer the processing result to the latter data node in the target data node pair. For example, the target data node pair composed of No. 1 and No. 2 data nodes can be associated with three candidate feature extraction methods, which are convolution processing, pooling processing, and direct replacement processing. The convolution processing is used to perform convolution processing on data of No. 1 data node, and input the processing result to No. 2 data node; and the direct replacement processing is used to perform no processing on data of No. 1 data node, and input the processing result to No. 2 data node.

Among the candidate feature extraction methods associated with the target data node, each candidate feature extraction method has a corresponding weight value, wherein the weight value can be arbitrary. The weight values of all candidate feature extraction methods constitute the first connection vector. Normalization processing is performed on the first connection vectors to obtain a one-hot vector, that is, obtain a first feature vector with only one element having a value 1, and the remaining elements having a value 0. The method of normalizing the first connection vector can be implemented by using the Softmax function. In the obtained first feature vector, the feature extraction method corresponding to the element with the value of 1 is the feature extraction method to be adopted for the data of the previous data node. In this way, after the data of the previous data node is processed by the feature extraction method corresponding to the element having the value 1, the processed data is transferred to the subsequent data node.

For example, as shown in FIG. 3, assuming that the first and second data nodes constitute the target data node pair and are associated with three candidate feature extraction methods, namely convolution processing, pooling processing, and direct replacement processing, namely. That is, there are three candidate processing layers between No. 1 data node and No. 2 data node, which are a convolutional layer, a pooling layer, and a direct replacement layer. The weight values of the three candidate feature extraction methods are a, b, and c respectively. The weight values a, b, and c constitute the first connection vector L=(a, b, c), and the Softmax function is used to perform normalizing process on the first connection vector L=(a, b, c) to obtain the first feature vector Z=(0, 1, 0), wherein the feature extraction method corresponding to the element with a value of 1 is to be used as the feature extraction method for the data of No. 1 data node. Therefore, the processing layer between No. 1 data node and No. 2 data node is the pooling layer, that is, the data on No. 1 data node is pooled and transferred to No. 2 data node. After determining the feature extraction method for transferring data from front to back between any two data nodes, that is, after determining the feature extraction method for No. 0 and No. 1 data nodes, No. 0 and No. 2 data nodes, No. 0 and No. 3 data nodes, No. 1 and No. 2 data nodes, No. 1 and No. 3 data nodes, and No. 2 and No. 3 data nodes, the feature extraction method for the basic cell has been obtained. Determining the feature extraction method for the basic cell means determining an internal structure of a basic cell.

FIG. 4 is a schematic structural diagram illustrating a basic cell after a processing layer between data nodes is determined according to an example of the present disclosure. As shown in FIG. 4, after determining the feature extraction method adopted for transferring data from front to back between any two data nodes, the processing layer between the data nodes is one of all types of processing layers.

When determining the feature extraction method used in each time of feature extraction process except the first time of feature extraction of the n times of feature extraction, the method can further include: with a graph convolution method, based on the feature extraction method used in the previous time of feature extraction process adjacent to that time of feature extraction process, correcting each first feature vector in that time of feature extraction process; based on the corrected first feature vectors, determining the feature extraction method used in that time of feature extraction process. Specifically, a connection matrix between a first matrix and a second matrix is determined, wherein the first matrix is a matrix composed of the feature extraction method used in the adjacent previous time of feature extraction process, and the second matrix is a matrix composed of first feature vectors in that time of feature extraction process; a correlation value between the connection matrix and the first matrix is determined, and the correlation value is added to the second matrix to obtain a third matrix; and based on the third matrix, the corrected first feature vectors are determined.

The basic cells are labeled with preset cell serial numbers, and a list of cell serial numbers are constituted by the serial numbers of all basic cells. In the list of cell serial numbers, the higher the cell serial number is, the higher the level of the corresponding basic cell is located. For example, in the list of cell serial numbers (0, 1, 2, . . . , 10), the basic cell with cell serial numbers 0 is the first basic cell of the neural network, and the basic cell with cell serial numbers 10 is the last basic cell of the neural network.

This method uses graph convolutional network as a communication mechanism between basic cells, and uses the feature extraction method used in the previous time of feature extraction process adjacent to make decision for the feature extraction method used in that time of feature extraction process, which can effectively improve recognition accuracy and recognition efficiency of the image recognition. Specifically, using the feature extraction method used in the previous time of feature extraction process adjacent to make decision for the feature extraction method used in that time of feature extraction process can include: determining a correlation value between the first matrix composed of the feature extraction methods used in the adjacent previous time of feature extraction process, and the second matrix composed of first feature vectors in that time of feature extraction process; adding the calculated correlation value to the second matrix to obtain the third matrix; correcting each first feature vector in that time of feature extraction process based on the third matrix, to obtain corrected first feature vectors to form the corrected feature extraction method of that time of feature extraction process. The above steps are repeated until the corrected feature extraction methods of all basic cells except the first basic cell are determined. This is because there are no other basic cells before the first basic cell, and the feature extraction methods of other basic cells cannot be used to make decision for the feature extraction process of the first basic cell. In other words, the feature extraction method of the first basic cell is determined by the first feature vectors of the data nodes of the first basic cell. In any two adjacent basic cells of the neural network, a basic cell with a smaller cell serial number is an upper basic cell, and a basic cell with a larger cell serial number is a lower basic cell.

For each time of feature extraction in n times of feature extraction except for the first time of feature extraction, determining a correlation value between the first matrix composed of the feature extraction methods used in the adjacent previous time of feature extraction process, and the second matrix composed of first feature vectors in that time of feature extraction process can specifically include: using matrix αⁿ⁻¹ to represent the first matrix, using matrix αⁿ to represent the second matrix, and using matrix Adj to represent a connection matrix of αⁿ⁻¹ and αⁿ, wherein Adj=αⁿ*αⁿ⁻¹ ^{^{T}}, and αⁿ⁻¹^{^{T}} represents a transpose matrix of the first matrix αⁿ⁻¹, the connection matrix Adj can be used to describe the connection relationship between the two matrices αⁿ⁻¹ and αⁿ; using graph convolutional neural network GCN to calculate the correlation value Δα=GCN(Adj, αⁿ⁻¹, W), wherein W is a preset parameter.

In another example, the first matrix αⁿ⁻¹ can also be input to a fully connected layer for linear feature processing, and the processed matrix can be input into the graph convolutional neural network GCN to obtain the correlation value Δα.

After the correlation value Δα is calculated, the correlation value Δα is added to the second matrix αⁿ to obtain the third matrix. Based on the third matrix, the corrected first feature vectors of the data nodes in that time of feature extraction process are determined. The above steps are repeated until the corrected first feature vectors of data nodes of all the basic cells except the first basic cell have been calculated, so as to determine the corrected feature extraction process method of all the feature extraction processes except the first time of feature extraction process.

Based on the first feature vectors of the data nodes of the first basic cell, a processing layer between the data nodes of the first basic cell is determined, that is, a topological structure of the first basic cell is determined, and then the first basic cell can be searched out based on the determined topological structure. Based on the corrected first feature vectors of the data nodes of the other basic cells except the first basic cell, the processing layers between the data nodes of other basic cells are determined, that is, the topological structures of other basic cells are determined, and then other basic cells can be searched out based on the determined topological structures. In this way, the entire neural network can be effectively searched through a search method.

In each time of feature extraction process, feature extraction process methods associated with any two target data nodes can be independent of each other. Therefore, the feature extraction methods used in each time of feature extraction process are independent and diverse, and make the multiple times of feature extraction processes on a to-be-processed image using the neural network to be diverse and extensive. When the basic cell (i.e., neural network basic cell) obtained by the above search method is used to form a neural network for image recognition processing, it can effectively avoid the exponential reduction of feature extraction methods. Moreover, by using the graph convolutional network as a communication mechanism, using the feature extraction method adopted in the adjacent previous time of feature extraction process, a more optimized feature extraction method can be decided for that time of feature extraction process, which can effectively improve the recognition accuracy and recognition efficiency of image recognition.

Step 203, feature extraction of at least one scale is performed on the pixel feature recognition result of the to-be-processed image to obtain a feature extraction result of at least one scale of the to-be-processed image.

In this example, the feature cell of the neural network can be used to perform feature extraction of at least one scale on the pixel feature recognition result of the to-be-processed image, to obtain feature extraction results of different scales of the to-be-processed image.

As mentioned above, the basic cell of the neural network is used to perform feature extraction process based on individual pixels on the to-be-processed image. After using each basic cell of the neural network to perform feature extraction process on the to-be-processed image, the pixel feature recognition result of the to-be-processed image is obtained. The feature cell of the neural network is used to perform multi-pixel feature extraction based on the pixel feature recognition result of the to-be-processed image, that is, to perform feature extraction of at least one scale on the pixel feature recognition result to obtain feature extraction results of at least one scale of the to-be-processed image. The feature cell includes at least one feature data node, and each of the feature data nodes performs a feature extraction process of one scale on the pixel feature recognition result, and the feature extraction methods adopted by the at least one feature data node can be independent of each other, that is, different feature data nodes can perform feature extraction process of different scales on pixel feature recognition results. Feature extraction of different scales refers to global feature extraction or various local feature extraction.

In this example, the feature cell is composed of at least one feature data node, and each feature data node can be associated with at least one candidate feature extraction method, such as convolution processing, pooling processing, and direct replacement processing. Specifically, there can be multiple processing layers between each feature data node in the feature cell and the lowest level basic cell, including a convolutional layer, a pooling layer, and a direct replacement layer. For example, FIG. 5 is a schematic diagram illustrating the connection between the feature cell 502 and the basic cell 501 of the lowest layer according to this example. As shown in FIG. 5, the feature cell 502 is composed of 5 feature data nodes, and there are 12 candidate processing layers between each feature data node and the lowest basic cell 501, including a deep separable convolutional layer having widths of 6, 10, 12, and 18 respectively, a global average pooling layer having sizes of 2, 3, 5, 6, and 10 respectively, a 1×1 convolutional layer, and a direct replacement layer.

Any feature data node is selected as a target feature data node, and a second connection vector is formed with the weight values of all candidate feature extraction methods associated with the target feature data node, wherein the weight value of each candidate feature extraction method is arbitrary. The second connection vector is normalized to obtain a one-hot vector, that is, a second feature vector with only one element having a value 1 and the remaining elements all having a value 0 is obtained. The method of normalizing the second connection vector can be realized by using the Softmax function. In the obtained second feature vector, the candidate feature extraction method corresponding to the element having a value 1 is the feature extraction method to be used for processing the pixel feature recognition result of the to-be-processed image by the target feature data node, which can also be referred to as a target feature extraction method associated with the target feature data node. After determining the target feature extraction methods associated with all the feature data nodes, the types of the processing layers between all the feature data nodes and the last basic cell are determined, that is, the topological structure of the feature cell is determined. Then, based on the determined topological structure of the feature cell, the corresponding feature cell can be searched out.

FIG. 6 is a schematic diagram illustrating the connection structure between the feature cell 602 and the last basic cell 601 after the processing layer is determined according to an example of the application. As shown in FIG. 6, the type of the processing layer between each feature data node constituting the feature cell 602 and the last basic cell 601 is determined. That is, the feature extraction method used by each feature data node constituting the feature cell 602 for processing the pixel feature recognition result output by the last basic cell 601 is determined.

Step 204, the to-be-processed image is processed based on the feature extraction result of at least one scale of the to-be-processed image.

For example, the pixel feature classification is performed on the to-be-processed image based on the feature extraction result of at least one scale of the to-be-processed image. For example, the pixels belonging to the same object category can be determined as belonging to the same pixel feature classification, and then the pixels belonging to the same pixel feature classification can be divided into the same object area, and the pixels of the same object area can be assigned with the same number to complete recognition of the content of the to-be-processed image.

In this example, the associated target feature extraction process methods of any two data nodes in each time of feature extraction process are independent of each other, which can ensure the independence and diversity when using the basic cell to extract features of the to-be-processed image. The obtained pixel feature recognition results can have high accuracy and significant reference value. By using the graph convolutional network as a communication mechanism, each time of feature extraction except the first time of feature extraction in n times of feature extraction performed by the basic cell, makes decision based on the feature extraction method used in the adjacent previous time of feature extraction provides decision for the feature extraction method used in that time of feature extraction, which can effectively ensure the recognition accuracy of the pixel feature recognition result. The target feature extraction methods associated with at least one feature data node constituting the feature cell of the neural network are respectively independent, which can ensure the diversity of feature extraction of at least one scale performed on the pixel feature recognition result of the to-be-processed image by the feature cell, which can be beneficial to improve the accuracy of the image recognition result. Since the feature extraction methods used in the feature extraction processes may not be exactly the same, this can effectively ensure the diversity and extensiveness of the processing methods of the neural network, and can effectively ensure the image recognition performance of the neural network.

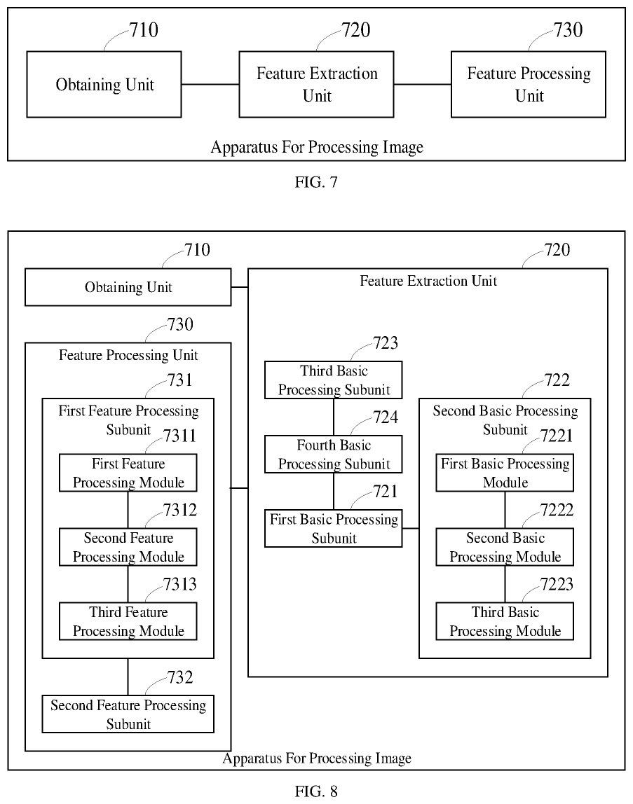

FIG. 7 is a block diagram illustrating an apparatus for processing an image according to an example of the present disclosure. As shown in FIG. 7, the apparatus includes: an obtaining unit 710 configured to obtain a to-be-processed image; a feature extraction unit 720 configured to perform n times of feature extraction on the to-be-processed image to obtain a pixel feature recognition result of the to-be-processed image; and a feature processing unit 730 configured to process the to-be-processed image based on the pixel feature recognition result of the to-be-processed image. Where, the input data of each of the n times of feature extraction is determined based on output data of previous k times of feature extraction; respective input data of the first to the k-th of the n times of feature extraction includes the to-be-processed image; k is an integer greater than or equal to 1 and less than n, and n is an integer greater than 1; each time of feature extraction process includes p data nodes, wherein p is an integer greater than 1, in each time of feature extraction process, the data on one data node is determined based on data obtained by processing data on each data node before the data node respectively via a preset feature extraction method in that time of feature extraction process and input data of that time of feature extraction; the feature extraction method used in each time of feature extraction process includes feature extraction methods used for data on the data nodes in that time of feature extraction process; and the feature extraction methods used in each time of feature extraction process are not exactly the same; and the output data of each time of feature extraction process is the data on the last data node in that time of feature extraction process.

In this example, since the feature extraction methods used in the multiple times of feature extraction processes are not exactly the same, thereby it can effectively ensure the diversity of image pixel feature recognition. In addition, since the feature extraction methods in multiple times of feature extraction processes are independent of each other, the independence of various feature extraction methods can be guaranteed, which can be beneficial to the realization of more accurate and fine-grained pixels feature recognition results.

FIG. 8 is a block diagram illustrating another apparatus for processing an image according to an example of the present disclosure. On the basis of the example shown in FIG. 7, as shown in FIG. 8, the feature extraction unit 720 includes a first basic processing subunit 721 configured to determine respective feature extraction methods for the n times of feature extraction, including: for each time of feature extraction process, selecting any one data node of that time of feature extraction and any data node after the data node to constitute a target data node pair, wherein the target data node pair is associated with multiple candidate feature extraction methods; constituting a first connection vector with weight values of all the multiple candidate feature extraction methods, wherein a weight value of each candidate feature extraction method can be arbitrary; normalizing the first connection vector, to obtain a first feature vector, with only one element of the first feature vector having a value 1 and the remaining elements all having a value 0; determining a candidate feature extraction method corresponding to an element with a value 1 as the target feature extraction method associated with the target data node pair, to be used to process data of the former data node in the target data node pair, and transfer the processed data to the latter data node in the target data node pair. In other words, the target feature extraction method associated with the target data node pair is the feature extraction method used by the former data node in the target data node pair to transfer data to the latter data node in the target data node pair.

The feature extraction unit 720 also includes: a second basic processing subunit 722 configured to, for each time of feature extraction process except the first time of feature extraction of the n times of feature extraction, with a graph convolution method, based on the feature extraction method used in the previous time of feature extraction process adjacent to that time of feature extraction process, correct each first feature vector in that time of feature extraction process. In this case, the first basic processing subunit 721 is configured to, based on the first feature vectors corrected by the second basic processing subunit 722, determine the feature extraction method used in that time of feature extraction process.

The second basic processing subunit 722 can include: a first basic processing module 7221 configured to determine a connection matrix between a first matrix and a second matrix, wherein the first matrix is a matrix composed of the feature extraction method used in the adjacent previous time of feature extraction process, and the second matrix is a matrix composed of first feature vectors in that time of feature extraction process; and a second basic processing module 7222 configured to determine a correlation value between the connection matrix and the first matrix, and add the correlation value to the second matrix to obtain a third matrix; and a third basic processing module 7223 configured to determine the corrected first feature vector based on the third matrix.

The feature processing unit 730 can include: a first feature processing subunit 731 configured to perform feature extraction of at least one scale on the pixel feature recognition result of the to-be-processed image to obtain a feature extraction result of at least one scale of the to-be-processed image; and a second feature processing subunit 732 configured to process the to-be-processed image based on the feature extraction result of at least one scale of the to-be-processed image.

The first feature processing subunit 731 can include: a first feature processing module 7311 configured to, for each of the at least one scale, form a second connection vector with the weight values of multiple candidate feature extraction methods associated with the scale, wherein the weight value of each candidate feature extraction method is arbitrary; a second feature processing module 7312 configured to normalize the second connection vector to obtain a second feature vector with only one element having a value 1 and the remaining elements all having a value 0; and a third feature processing module 7313 configured to determine a candidate feature extraction method corresponding to the element having a value 1 as the target feature extraction method associated with the scale, to perform feature extraction of the scale on the pixel feature recognition result of the to-be-processed image with the target feature extraction method.

The feature extraction unit 720 can also include: a third basic processing subunit 723 configured to, for an i-th time of feature extraction in the n times of feature extraction, when i is greater than or equal to 1 and less than or equal to k, determine the to-be-processed image as the input data of the i-th time of feature extraction, when i is greater than k and less than or equal to n, determine respective processing results of previous k times of feature extraction before the i-th time of feature extraction, including the (i−k)th processing result obtained by the (i−k)th time of feature extraction, . . . , the (i−1)th processing result obtained by the (i−1)th time of feature extraction, as the input data of the i-th time of feature extraction; and a fourth basic processing subunit 724 configured to process the input data determined by the third basic processing subunit 723 according to the feature extraction method determined by the first basic processing subunit 721, to obtain the i-th processing result of the i-th time of feature extraction.

In this example, in each time of feature extraction process with basic cells of the neural network, the associated feature extraction process methods of any two data nodes are independent of each other, which can ensure the independence and diversity when using each basic cell to extract features. The obtained pixel feature recognition results can have high accuracy and significant reference value. By using the graph convolutional network as a communication mechanism, each time of feature extraction except the first time of feature extraction in n times of feature extraction performed by the basic cell, makes decision based on the feature extraction method used in the adjacent previous time of feature extraction provides decision for the feature extraction method used in that time of feature extraction, which can effectively ensure the recognition accuracy of the pixel feature recognition result. The target feature extraction methods associated with at least one feature data node constituting the feature cell of the neural network are respectively independent, which can ensure the diversity of feature extraction of at least one scale performed on the pixel feature recognition result by the feature cell, which can be beneficial to improve the accuracy of the image recognition result. Since the feature extraction methods used in the feature extraction processes may not be exactly the same, this can effectively ensure the diversity and extensiveness of the processing methods of the neural network, and can effectively ensure the image recognition performance of the neural network.

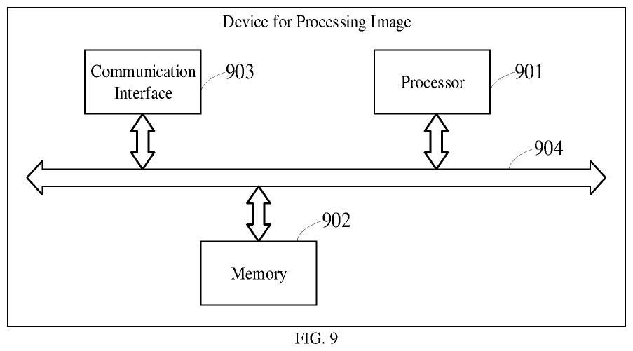

FIG. 9 is a block diagram illustrating a device for processing an image according to an example of the present disclosure. As shown in FIG. 9, an example of the present disclosure provides a device for processing an image, which can be configured to perform actions or steps of the image recognition processing device in the examples shown in FIGS. 1 and 2. The device for processing an image specifically includes a processor 901, a memory 902, and a communication interface 903. The memory 902 is used to store a computer program. The processor 901 is configured to execute the computer program stored in the memory 902 to implement the actions of the image recognition processing device in the example shown in FIG. 1 to FIG. 2, which will not be repeated.

Alternatively, the device for processing an image can further include a bus 904. The processor 901, the memory 902, and the communication interface 903 can be connected to one another via the bus 904. The bus 904 can be a Peripheral Component Interconnect (PCI) bus or an Extended Industry Standard Architecture (Extended Industry Standard Architecture, abbreviated as EISA) bus, or the like. The bus 904 can be classified into an address bus, a data bus, and a control bus. For ease of representation, the bus 904 is merely depicted as one thick line in FIG. 9, but it does not mean that there is only one bus or one type of bus.

In the examples of the present disclosure, the above examples can be referred to and used for reference, and the same or similar steps and terms are not repeated one by one.

Alternatively, part or all of the above modules can also be implemented in the form of an integrated circuit embedded on a chip of an image recognition processing device. They can be implemented separately or integrated. That is to say, the modules can be configured as one or more integrated circuits that implement the above methods, for example: one or more Application Specific Integrated Circuits (ASICs for short), or one or more Digital Signal Processors (DSPs for short), or, one or more Field Programmable Gate Arrays (FPGAs for short).

A computer-readable storage medium on which a computer program is stored, and the computer program is executed by a processor to implement the processing method.

In the above examples, it can be implemented in whole or in part by software, hardware, firmware, or any combination thereof. When implemented by software, it can be implemented in the form of a computer program product in whole or in part. The computer program product includes one or more computer instructions. When the computer program instructions are loaded and executed on the computer, the processes or functions according to the examples of the present disclosure are generated in whole or in part. The computer can be a general-purpose computer, a dedicated computer, a computer network, or other programmable devices. Computer instructions can be stored in a computer-readable storage medium, or transmitted from one computer-readable storage medium to another computer-readable storage medium. For example, computer instructions can be transferred from a website, computer, image recognition processing device, or data center in a wired (for example, coaxial cable, optical fiber, digital subscriber line (DSL)) or wireless (for example, infrared, wireless, microwave, etc) manner to another website site, computer, image recognition processing device or data center. The computer-readable storage medium can be any available medium that can be accessed by a computer or a data storage device such as an image recognition processing device or a data center integrated with one or more available media. The usable medium can be a magnetic medium (for example, a floppy disk, a hard disk, a magnetic tape), an optical medium (for example, a DVD), or a semiconductor medium (for example, a solid state disk (SSD)), or the like.

Those skilled in the art should be aware that, in one or more of the foregoing examples, the functions described in the examples of the present disclosure can be implemented by hardware, software, firmware, or any combination thereof. When implemented by software, these functions can be stored in a computer-readable medium or transmitted as one or more instructions or codes on the computer-readable medium. The computer-readable medium includes a computer storage medium and a communication medium, wherein the communication medium includes any medium that facilitates the transfer of a computer program from one place to another. The storage medium can be any available medium that can be accessed by a general-purpose or special-purpose computer.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

What is claimed is:

1. A method for processing an image, comprising:
obtaining a to-be-processed image;
performing n times of feature extraction on the to-be-processed image, to obtain a pixel feature recognition result of the to-be-processed image, wherein:
input data of each time of feature extraction is determined based on output data of previous k times of feature extraction;
input data of a first time of feature extraction to k-th times of feature extraction include the to-be-processed image, wherein k is an integer greater than or equal to 1 and less than n, and n is an integer greater than 1;
each time of feature extraction includes p data nodes, wherein p is an integer greater than 1;
in each time of feature extraction, data on one data node is determined based on data obtained by processing data on each of data nodes before the data node respectively via a preset feature extraction method in the feature extraction and input data of the feature extraction;
a feature extraction method used in each time of feature extraction includes feature extraction methods used for data on the data nodes in the feature extraction; and
output data of each time of feature extraction is data on the last data node in the feature extraction; and
processing the to-be-processed image based on the pixel feature recognition result of the to-be-processed image.

2. The method of claim 1, wherein the method for processing an image is executed by a neural network, and each time of feature extraction in the n times of feature extraction is executed by a basic cell in the neural network.

3. The method of claim 1, wherein for each time of feature extraction in the n times of feature extraction, the feature extraction method used in the feature extraction is determined by:
selecting any one data node of the feature extraction and any data node after the data node to constitute a target data node pair, wherein the target data node pair is associated with multiple candidate feature extraction methods;
constituting a first connection vector with weight values of all of the multiple candidate feature extraction methods, wherein a weight value of each candidate feature extraction method is an arbitrary value;
normalizing the first connection vector, to obtain a first feature vector, with only one element of the first feature vector having a value 1 and remaining elements all having a value 0; and
determining a candidate feature extraction method corresponding to the element with a value 1 as a target feature extraction method associated with the target data node pair, to be used to process data of a former data node in the target data node pair, and transfer the processed data to a latter data node in the target data node pair.

4. The method of claim 2, wherein for each time of feature extraction in the n times of feature extraction, the feature extraction method used in the feature extraction is determined by:
selecting any one data node of the feature extraction and any one data node after the data node to constitute a target data node pair, wherein the target data node pair is associated with multiple candidate feature extraction methods;
constituting a first connection vector with weight values of all of the multiple candidate feature extraction methods, wherein a weight value of each candidate feature extraction method is an arbitrary value;
normalizing the first connection vector, to obtain a first feature vector, with only one element of the first feature vector having a value 1 and remaining elements all having a value 0; and
determining a candidate feature extraction method corresponding to the element with a value 1 as a target feature extraction method associated with the target data node pair, to be used to process data of a former data node in the target data node pair, and transfer the resulted data from the process to a latter data node in the target data node pair.

5. The method of claim 3, wherein when determining the feature extraction method used in the feature extraction, the method further comprises:
correcting each first feature vector in the feature extraction with a graph convolution method based on the feature extraction method used in a previous time of feature extraction adjacent to the feature extraction; and
determining the feature extraction method used in the feature extraction based on the corrected first feature vectors.

6. The method of claim 5, wherein correcting each first feature vector in the feature extraction with a graph convolution method based on the feature extraction method used in the previous time of feature extraction adjacent to the feature extraction comprise:
determining a connection matrix between a first matrix and a second matrix, wherein the first matrix is a matrix composed of the feature extraction method used in the adjacent previous time of feature extraction, and the second matrix is a matrix composed of first feature vectors in the feature extraction;
determining a correlation value between the connection matrix and the first matrix, and adding the correlation value to the second matrix to obtain a third matrix; and
determining a corrected first feature vector in the feature extraction based on the third matrix.

7. The method of claim 1, wherein processing the to-be-processed image based on the pixel feature recognition result of the to-be-processed image comprises:
performing feature extraction of at least one scale on the pixel feature recognition result of the to-be-processed image, to obtain a feature extraction result of at least one scale of the to-be-processed image; and
processing the to-be-processed image based on the feature extraction result of at least one scale of the to-be-processed image.

8. The method of claim 2, wherein processing the to-be-processed image based on the pixel feature recognition result of the to-be-processed image comprises:
performing feature extraction of at least one scale on the pixel feature recognition result of the to-be-processed image, to obtain a feature extraction result of at least one scale of the to-be-processed image; and
processing the to-be-processed image based on the feature extraction result of at least one scale of the to-be-processed image.

9. The method of claim 7, wherein for feature extraction of each scale in the feature extraction of the at least one scale, determining the feature extraction method of the scale by:
constituting a second connection vector with weight values of multiple candidate feature extraction methods associated with the scale, wherein a weight value of each candidate feature extraction method is an arbitrary value;
normalizing the second connection vector to obtain a second feature vector with only one element having a value 1 and remaining elements all having a value 0; and
determining a candidate feature extraction method corresponding to the element having a value 1 as a target feature extraction method associated with the scale, to perform feature extraction of the scale on the pixel feature recognition result of the to-be-processed image with the target feature extraction method.

10. The method of claim 1, wherein for an i-th time of feature extraction in the n times of feature extraction, determining input data of the i-th time of feature extraction by:
when i is greater than or equal to 1 and less than or equal to k, determining the to-be-processed image as the input data of the i-th time of feature extraction;
when i is greater than k and less than or equal to n, determining respective output data of previous k times of feature extraction before the i-th time of feature extraction as the input data of the i-th time of feature extraction, wherein the respective output data of previous k times of feature extraction before the i-th time of feature extraction includes an (i−k)th processing result obtained by processing input data with a preset feature extraction method in an (i−k)th time of feature extraction to an (i−1)th processing result obtained by processing input data with a preset feature extraction method in an (i−1)th time of feature extraction.

11. A device for processing an image, comprising: a processor, a memory, and a computer readable program,
wherein the computer readable program is stored in the memory and is executable by the processor to cause the processor to:
obtain a to-be-processed image;
perform n times of feature extraction on the to-be-processed image, to obtain a pixel feature recognition result of the to-be-processed image, wherein:
input data of each time of feature extraction is determined based on output data of previous k times of feature extraction;
input data of a first time of feature extraction to k-th times of feature extraction include the to-be-processed image, wherein k is an integer greater than or equal to 1 and less than n, and n is an integer greater than 1;
each time of feature extraction includes p data nodes, wherein p is an integer greater than 1;
in each time of feature extraction, data on one data node is determined based on data obtained by processing data on each of data nodes before the data node respectively via a preset feature extraction method in the feature extraction and input data of the feature extraction;
a feature extraction method used in each time of feature extraction includes feature extraction methods used for data on the data nodes in the feature extraction; and
output data of each time of feature extraction is data on the last data node in the feature extraction; and
process the to-be-processed image based on the pixel feature recognition result of the to-be-processed image.

12. The device of claim 11, wherein the computer readable program is executed by a neural network, and each time of feature extraction in the n times of feature extraction is executed by a basic cell in the neural network.

13. The device of claim 11, wherein for each time of feature extraction in the n times of feature extraction, the feature extraction method used in the feature extraction is determined by:
selecting any one data node of the feature extraction and any one data node after the data node to constitute a target data node pair, wherein the target data node pair is associated with multiple candidate feature extraction methods;
constituting a first connection vector with weight values of all of the multiple candidate feature extraction methods, wherein a weight value of each candidate feature extraction method is an arbitrary value;
normalizing the first connection vector, to obtain a first feature vector, with only one element of the first feature vector having a value 1 and remaining elements all having a value 0; and
determining a candidate feature extraction method corresponding to the element with a value 1 as a target feature extraction method associated with the target data node pair, to be used to process data of a former data node in the target data node pair, and transfer the processed data to a latter data node in the target data node pair.

14. The device of claim 12, wherein for each time of feature extraction in the n times of feature extraction, the feature extraction method used in the feature extraction is determined by:
selecting any one data node of the feature extraction and any one data node after the data node to constitute a target data node pair, wherein the target data node pair is associated with multiple candidate feature extraction methods;
constituting a first connection vector with weight values of all of the multiple candidate feature extraction methods, wherein a weight value of each candidate feature extraction method is an arbitrary value;
normalizing the first connection vector, to obtain a first feature vector, with only one element of the first feature vector having a value 1 and remaining elements all having a value 0; and
determining a candidate feature extraction method corresponding to the element with a value 1 as a target feature extraction method associated with the target data node pair, to be used to process data of a former data node in the target data node pair, and transfer the resulted data from the process to a latter data node in the target data node pair.

15. The device of claim 13, wherein when determining the feature extraction method used in the feature extraction, the processor is further configured to perform:
correcting each first feature vector in the feature extraction with a graph convolution method based on the feature extraction method used in a previous time of feature extraction adjacent to the feature extraction; and
determining the feature extraction method used in the feature extraction based on the corrected first feature vectors.

16. The device of claim 15, wherein correcting each first feature vector in the feature extraction with a graph convolution method based on the feature extraction method used in the previous time of feature extraction adjacent to the feature extraction comprise:
determining a connection matrix between a first matrix and a second matrix, wherein the first matrix is a matrix composed of the feature extraction method used in the adjacent previous time of feature extraction, and the second matrix is a matrix composed of first feature vectors in the feature extraction;
determining a correlation value between the connection matrix and the first matrix, and adding the correlation value to the second matrix to obtain a third matrix; and
determining a corrected first feature vector in the feature extraction based on the third matrix.

17. The device of claim 11, wherein processing the to-be-processed image based on the pixel feature recognition result of the to-be-processed image comprises:
performing feature extraction of at least one scale on the pixel feature recognition result of the to-be-processed image, to obtain a feature extraction result of at least one scale of the to-be-processed image; and
processing the to-be-processed image based on the feature extraction result of at least one scale of the to-be-processed image.

18. The device of claim 17, wherein for feature extraction of each scale in the feature extraction of the at least one scale, determining the feature extraction method of the scale by:
constituting a second connection vector with weight values of multiple candidate feature extraction methods associated with the scale, wherein a weight value of each candidate feature extraction method is an arbitrary value;
normalizing the second connection vector to obtain a second feature vector with only one element having a value 1 and remaining elements all having a value 0; and
determining a candidate feature extraction method corresponding to the element having a value 1 as a target feature extraction method associated with the scale, to perform feature extraction of the scale on the pixel feature recognition result of the to-be-processed image with the target feature extraction method.

19. The device of claim 11, wherein for an i-th time of feature extraction in the n times of feature extraction, determining input data of the i-th time of feature extraction by:
when i is greater than or equal to 1 and less than or equal to k, determining the to-be-processed image as the input data of the i-th time of feature extraction;
when i is greater than k and less than or equal to n, determining respective output data of previous k times of feature extraction before the i-th time of feature extraction as the input data of the i-th time of feature extraction, wherein the respective output data of previous k times of feature extraction before the i-th time of feature extraction includes an (i−k)th processing result obtained by processing input data with a preset feature extraction method in an (i−k)th time of feature extraction to an (i−1)th processing result obtained by processing input data with a preset feature extraction method in an (i−1)th time of feature extraction.

20. A non-transitory computer-readable storage medium having a computer program stored thereon, the computer program being executed by a processor to implement the method of claim 1.
